(19) United States
(12) Patent Application Publication
(10) Pub. No.: US 2009/0056559 A1
(43) Pub. Date: Mar. 5, 2009

(54) COOKING APPARATUS AND METHOD

(76) Inventor: Nazrelee N. Dunham, Mastic, NY (US)

Correspondence Address: Mr. Walter J. Tencza Jr., 10 Station Place, Suite 3, Metuchen, NJ, 08840, US

(21) Appl. No.: 11/845,848

(22) Filed: Aug. 28, 2007

(51) Int. Cl. A47J 36/00; A47J 27/00; A47J 36/06; B21D 39/00

(52) U.S. Cl. 99/335; 29/428; 99/324

(57) ABSTRACT

An apparatus is provided including a cooking device having a peripheral wall, a bottom, and a divider. The peripheral wall and the bottom typically enclose an overall chamber. The divider divides the overall chamber into a first and a second chamber. The apparatus may further include a lid which can cover the overall chamber. A timer device may be mounted to the lid. The timer device may be mounted to the lid so that the timer device is spaced apart from a top surface of the lid.

### FIELD OF THE INVENTION

This invention relates to improved methods and apparatus concerning cooking devices.

### BACKGROUND OF THE INVENTION

There are various devices known in the prior art for cooking.

### SUMMARY OF THE INVENTION

In at least one embodiment of the present invention an apparatus is provided including a cooking device having a peripheral wall, a bottom, and a divider. The peripheral wall and the bottom typically enclose an overall chamber. The divider divides the overall chamber into a first and a second chamber. The apparatus may further include a lid which can cover the overall chamber. A timer device may be mounted to the lid. The timer device may be mounted to the lid so that the timer device is spaced apart from a top surface of the lid.

The cooking device may be a pot. The pot may be substantially circular or cylindrical. The cooking device may alternatively be a frying pan, which may be substantially rectangular.

The present invention, in at least one embodiment also provides a method comprising inserting a divider into a cooking device. The cooking device may have a peripheral wall and a bottom. The peripheral wall and the bottom may enclose an overall chamber. The divider divides the overall chamber into a first and a second chamber. The method may further include placing a lid over the overall chamber and mounting a timer device mounted to the lid.

### BRIEF DESCRIPTION OF THE DRAWINGS

FIG. 1 shows a side view of a pot in accordance with an embodiment of the present invention;

FIG. 2 shows a top view of the pot of FIG. 1;

FIG. 3 shows a bottom view of the pot of FIG. 1;

FIG. 4 shows a rear view of the pot of FIG. 1;

FIG. 5 shows a perspective view of the pot of FIG. 1;

FIG. 6A shows a perspective view of a lid with a timer for use with the pot of FIG. 1 in accordance with an embodiment of the present invention;

FIG. 6B shows a closeup top view of the timer for use with the lid of FIG. 6A;

FIG. 7 shows a perspective view of the lid of FIG. 6A placed onto the pot of FIG. 1;

FIG. 8A shows a perspective view of a rectangular pot in accordance with another embodiment of the present invention;

FIG. 8B shows a perspective view of a rectangular lid with a timer for use with the pot of FIG. 8A in accordance with an embodiment of the present invention; and

FIG. 8C shows a perspective view of the lid of FIG. 8A placed onto the pot of FIG. 8B.

### DETAILED DESCRIPTION OF THE DRAWINGS

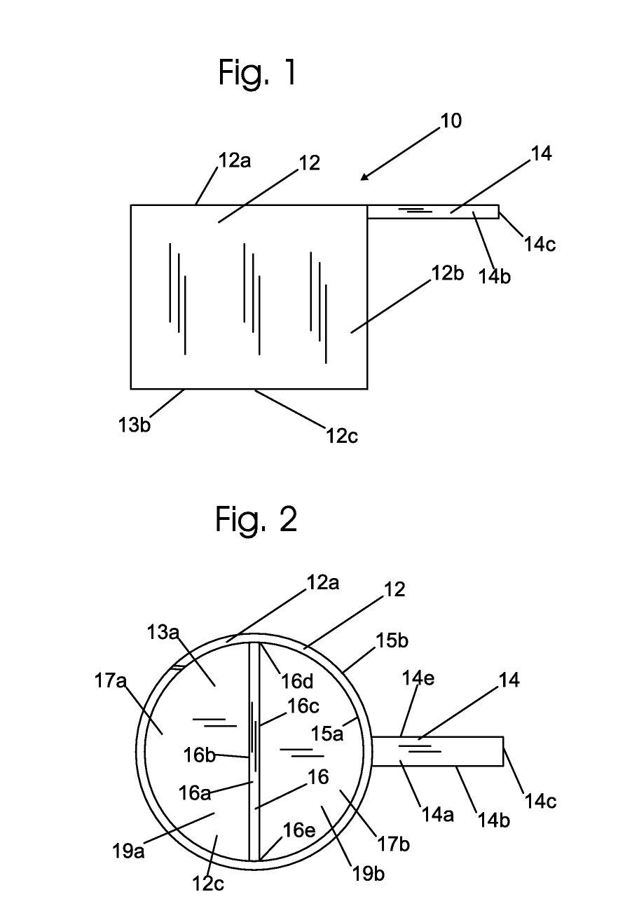

FIGS. 1-5 shows side, top, bottom, rear, and perspective views of a pot 10 in accordance with an embodiment of the present invention. The pot 10 may be an example of a cooking device of cooking receptacle. The pot 10 is typically a cooking pot which may be made of metal. The pot 10 is comprised of a body portion 12, a handle 14, and a divider 16.

Referring to FIGS. 1-5, the body portion 12 includes a top edge 12a, a peripheral wall 12b, and a bottom 12c. The bottom 12c includes an inner surface 13a shown in FIG. 2 and an outer surface 13b shown in FIG. 1. The peripheral wall 12b includes an inner surface 15a and an outer surface 15b.

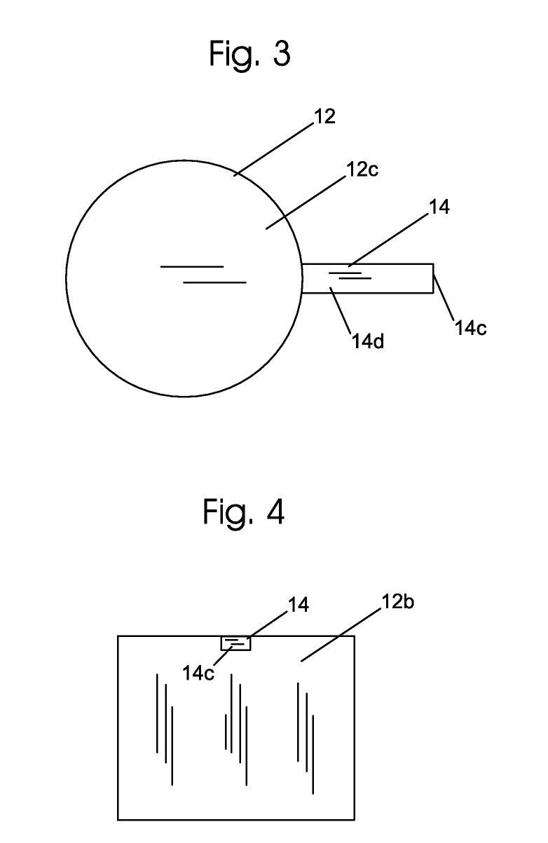

The handle 14 includes a top surface 14a shown in FIG. 2, side surfaces 14b and 14e whose location is shown in FIG. 2, an edge 14c shown in FIGS. 1-4, and a bottom surface 14d shown in FIG. 3. The handle 14 is fixed to the outer surface 15b of the peripheral wall 12b of the body portion 12 of the pot 10. The handle 14 may be integrated or molded with the body portion 10. The handle 14 may be made of metal, plastic, rubber covering or other material.

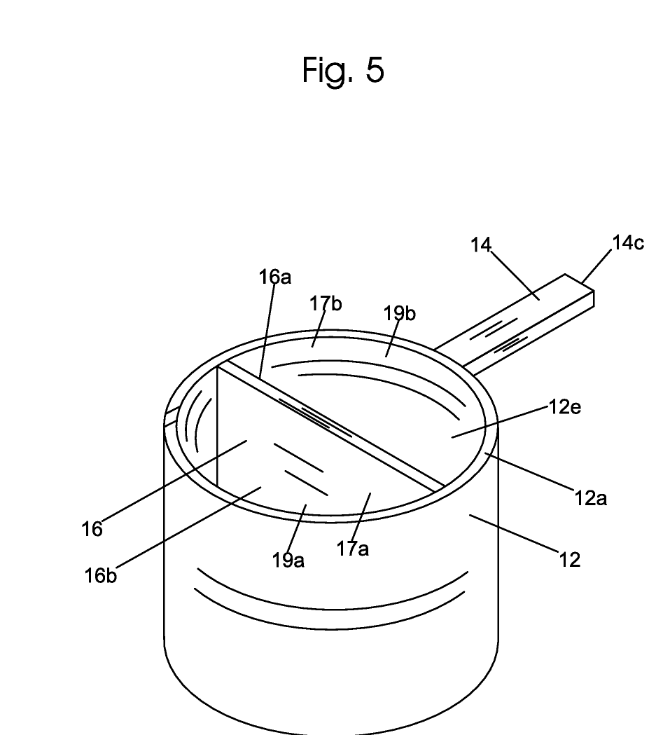

The divider 16 may be made of metal and may be the same material as the body portion 12. The divider 16 may include a top edge 16a, side surfaces 16b and 16c, and ends 16d and 16e, shown by FIG. 2. The ends 16d and 16e may be fixed or integrated with the inside surface 15a of the peripheral wall 12b of the body portion 12 of the pot 10. The divider 16 may divide a volume or overall chamber enclosed by the peripheral wall 12b and the bottom 12c into two chambers, which are identified as chambers 17a and 17b in FIGS. 2 and 5. Openings 19a and 19b may lead into the chambers 17a and 17b, respectively. Each of the openings 19a and 19b may be substantially circular, and the area of chamber 17a may be substantially equal to the area of chamber 17b. The chamber 17a is bounded by divider 16, a portion of peripheral wall 12b, and bottom 12c. The chamber 17b is bounded by divider 16, a portion of peripheral wall 12b, and bottom 12c.

The divider 16 may be permanent and can be used to separate different types of food in the pot 10 or body portion 12 of the pot 10. For example, chamber 17b may have one type of food cooking while chamber 17a may have another type of food cooking.

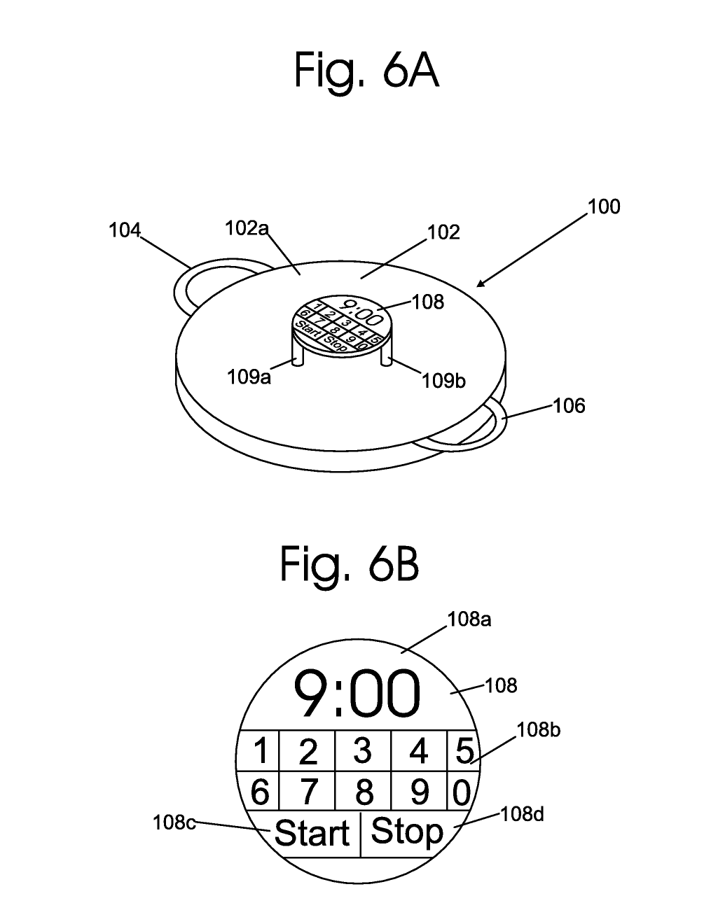

FIG. 6A shows a perspective view of a lid 100 for use with the pot 10 of FIG. 1 in accordance with an embodiment of the present invention. The lid 100 includes handles a body portion 102, handles 104 and 106, and a timer device 108. The body portion 102 has a top surface 102a. The handles 104 and 106 may be fixed to the body portion 102 so that the handles 104 and 106 substantially oppose one another. The timer device 108 may be fixed substantially centrally to the body portion 102 by mounting posts or pins 109a and 109b. The mounting posts or pins 109a and 109b may keep the timer device 108 raised off the top surface 102a of the body portion 102 so that the timer device 108 is not damaged by the body portion 102 becoming too hot. The mounting posts or pins 109a and 109b may be made of rubber, plastic, or an insulating material. The plastic material should be resistant to heat.

FIG. 6B shows a top view of the timer device 108. The timer device 108 may include a display, screen, or monitor 108a. The timer device may include plurality of buttons, or keyboard 108b, which may include buttons having numbers “1”, “2”, “3”, “4”, “5”, “6”, “7”, “8”, “9”, and “0” as shown in FIG. 6b. The display screen 108a may display a time left for cooking. The timer device 108 may work by counting down minutes on the display screen 108a until it reaches a desired time and then the timer device 108 may beep or make some other audible noise. The timer device 108 may include start button 108c and stop button 108d, which can be pressed to stop and start the timer device 108 from counting down on the display screen 108a.

The lid 100 provides a cover function which keeps steam in the chambers 17a and 17b to assist with cooking of food. The timer 108 alerts individuals to attend to the pot as needed and also helps to ensure that the food does not burn.

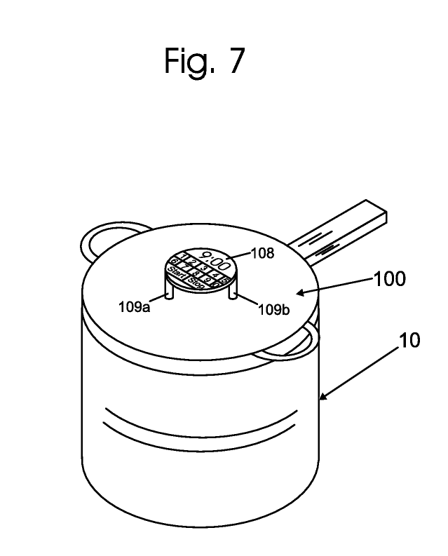

FIG. 7 shows a perspective view of the lid 100 placed onto the pot 10.

The lid 100 and pot 10 prevent food from burning and inhibit a fire from occurring.

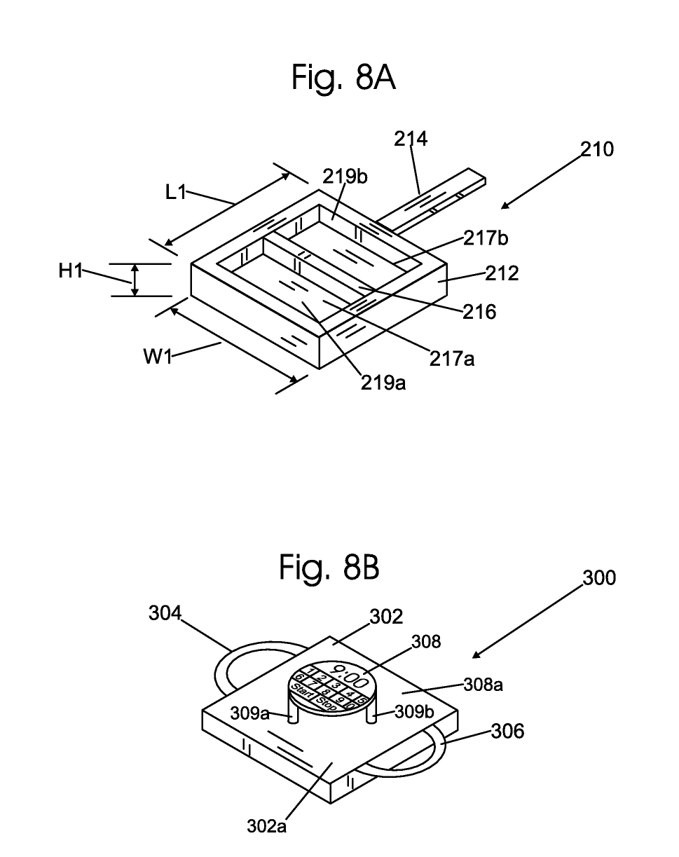

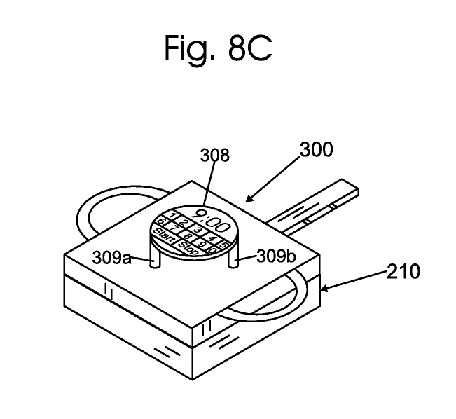

FIG. 8A shows a perspective view of a rectangular frying pan 210 in accordance with another embodiment of the present invention. FIG. 8B shows a perspective view of a rectangular lid 300 with a timer 308 for use with the rectangular frying pan 210 in accordance with an embodiment of the present invention. FIG. 8C shows a perspective view of the lid 300 of FIG. 8A placed onto the rectangular frying pan of 210 of FIG. 8B. The rectangular frying pan 210 may be square. The rectangular lid 300 may be square. The frying pan 210 may be an example of a cooking device or cooking receptacle.

The rectangular frying pan 210 may have a handle 214 and a body portion 212. The pan 210 may also have a divider 216 which divides an inner chamber of the pan 210 into chambers 217a and 217b having openings 219a and 219b, respectively. The rectangular frying pan 210 may be used for cooking similar to the pot 10. The rectangular frying pan 210 may be used for meats or other food. The frying pan 210 may have a height or depth of H1, a length of L1, and a width of W1. The width W1 may be equal to the Length of L1 in the case of a square frying pan. The length L1 and the width W1 are typically substantially greater than the height H1.

The lid 300 may include handles 304 and 306, body portion 302, and timer device 308. The body portion 302 may have a top surface 302a. The timer device 308 may be identical to or similar to the timer 108 shown for the lid 100. The timer device 308 may be mounted to the lid 300 by mounting posts or pins 309a and 309b, which may be made of an insulating material such as rubber, or an appropriate heat resistant plastic.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a cooking device having a peripheral wall and a bottom and a divider;
wherein the peripheral wall and the bottom enclose an overall chamber; and
wherein the divider divides the overall chamber into a first and a second chamber.

2. The apparatus of claim 1 further comprising
a lid which can cover the overall chamber.

3. The apparatus of claim 2 further comprising
a timer device mounted to the lid.

4. The apparatus of claim 3 wherein
the lid has a top surface;
and wherein the timer device is mounted to the lid so that the timer device is spaced apart from the top surface of the lid.

5. The apparatus of claim 1 wherein
the cooking device is a pot.

6. The apparatus of claim 1 wherein
the cooking device is a frying pan.

7. The apparatus of claim 5 wherein
the pot is substantially circular.

8. The apparatus of claim 6 wherein
the frying pan is substantially rectangular.

9. A method comprising:
inserting a divider into a cooking device;
wherein the cooking device has a peripheral wall and a bottom;
wherein the peripheral wall and the bottom enclose an overall chamber; and
wherein the divider divides the overall chamber into a first and a second chamber.

10. The method of claim 9 further comprising
placing a lid over the overall chamber.

11. The method of claim 10 further comprising
mounting a timer device mounted to the lid.

12. The method of claim 11 wherein
the lid has a top surface;
and wherein the timer device is mounted to the lid so that the timer device is spaced apart from the top surface of the lid.

13. The method of claim 9 wherein
the cooking device is a pot.

14. The method of claim 9 wherein
the cooking device is a frying pan.

15. The method of claim 13 wherein
the pot is substantially circular.

16. The method of claim 14 wherein
the frying pan is substantially rectangular.
